(19) United States
(12) Patent Application Publication
(10) Pub. No.: US 2006/0181611 A1
(43) Pub. Date: Aug. 17, 2006

(54) Video signal scanning method and apparatus

(75) Inventors: Jung-woo Kim, Yongin-si (KR); Jin-ho Lee, Suwon-si (KR); Yong-kweun Mun, Yongin-si (KR)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Samsung Electronics Co., Ltd., Suwon-si (KR)

(21) Appl. No.: 11/340,678

(22) Filed: Jan. 27, 2006

(30) Foreign Application Priority Data
Feb. 16, 2005 (KR) 10-2005-0012921

(51) Int. Cl. H04N 3/02

(52) U.S. Cl. 348/195

(57) ABSTRACT

A method and apparatus for scanning a video signal are provided. The method includes: detecting an operating frequency of a drive signal for an optical scanner which scans the video signal; detecting a sync signal error per frame between a vertical sync signal corresponding to the video signal and a horizontal sync signal corresponding to the operating frequency; adjusting a frequency of the vertical sync signal to allow the horizontal sync signal corresponding to the operating frequency to be synchronized with the vertical sync signal corresponding to the video signal, for each frame, in response to the sync signal error; and scanning the video signal according to the horizontal sync signal corresponding to the operating frequency and the vertical sync signal having an adjusted frequency.

### CROSS-REFERENCE TO RELATED PATENT APPLICATIONS

This application claims the benefit of Korean Patent Application No. 10-2005-0012921, filed on Feb. 16, 2005, in the Korean Intellectual Property Office, the disclosure of which is incorporated herein in its entirety by reference.

### BACKGROUND OF THE DISCLOSURE

1. Field of the Disclosure

The present disclosure relates to the scanning of a video signal, and more particularly, to a method and apparatus for adjusting a sync signal error of a vertical sync signal and a horizontal sync signal of a video signal and a drive signal of an optical scanner, and scanning the video signal according to the adjusted vertical sync signal.

2. Description of the Related Art

An optical scanner having a micro-electro-mechanical system (MEMS) which uses an electrostatic effect due to a comb-typed electrode structure is used as a micro-scanner for deflecting a laser beam in a projection TV. The optical scanner manufactured in units of microns has a structure in which a mirror is suspended to be able to seesaw on a support formed on a substrate such as a typical silicon on insulator (SOI) wafer. A plurality of movable comb electrodes are vertically formed at both surfaces of the mirror. A plurality of static comb electrodes are vertically installed on the SOI wafer substrate to alternate with the movable comb electrodes. When voltage having the opposite polarities are applied to the movable comb electrodes and the static comb electrodes, an electrostatic force is generated between the electrodes so that the mirror seesaws at high speed. Thus, a laser beam incident on the mirror according to a video signal can be deflected at a high speed.

In order to represent a high resolution image, the driving speed of the optical scanner must be fast, which signifies that the driving angle of the optical scanner increased accordingly. The driving angle of the optical scanner increases when the drive signal of the optical scanner is at a specific frequency. The specific frequency of the drive signal at which the driving angle of the optical scanner increases is referred to as a resonant frequency. FIG. 1 is a graph showing the relationship between the driving angle and the frequency of the optical scanner. Referring to FIG. 1, when the frequency is 33,000 Hz, that is, the resonant frequency of the drive signal of the optical scanner, the driving angle of the optical scanner becomes maximum and the high speed operation of the optical scanner is made possible.

However, due to deviation in the manufacturing process, it is difficult to obtain the drive signal of the optical scanner corresponding to the resonant frequency. Thus, when the optical scanner is driven according to a drive signal having a frequency different from the resonant frequency, the synchronism between the horizontal sync signal and the vertical sync signal of the video signal does not match. FIG. 2 is a waveform diagram of a sync signal error between the drive signal waveform of the optical scanner and the horizontal and vertical sync signals of the video signal. Referring to FIG. 2, when a sync signal error is not generated among the drive signal waveform of the optical scanner and the horizontal and vertical sync signals of the video signal (Case 1), the image is not distorted. However, when a sync signal error is generated among the drive signal waveform of the optical scanner and the horizontal and vertical sync signals of the video signal (Cases 2 and 3), the image is distorted.

### SUMMARY OF THE DISCLOSURE

To solve the above and/or other problems, the present invention provides a method for adjusting a sync signal error and scanning a video signal according to an adjusted vertical sync signal.

The present invention provides an apparatus for adjusting a sync signal error and scanning a video signal according to an adjusted vertical sync signal.

According to an aspect of the present invention, there may be provided a method for scanning a video signal, the method including: detecting an operating frequency of a drive signal for an optical scanner which scans the video signal; detecting a sync signal error per frame between a vertical sync signal corresponding to the video signal and a horizontal sync signal corresponding to the operating frequency; adjusting a frequency of the vertical sync signal to allow the horizontal sync signal corresponding to the operating frequency to be synchronized with the vertical sync signal corresponding to the video signal, for each frame, in response to the sync signal error; and scanning the video signal according to the horizontal sync signal corresponding to the operating frequency and the vertical sync signal having an adjusted frequency.

According to another aspect of the present invention, there may be provided an apparatus for scanning a video signal, the apparatus including: an optical scanner which scans a video signal; an operating frequency detection portion which detects an operating frequency of a drive signal for the optical scanner; a sync signal error detection portion which detects a sync signal error per frame between a vertical sync signal corresponding to the video signal and a horizontal sync signal corresponding to the operating frequency; and a vertical sync signal adjustment portion which adjusts a frequency of the vertical sync signal to allow the horizontal sync signal corresponding to the operating frequency to be synchronized with the vertical sync signal corresponding to the video signal, for each frame, in response to the detection result of the sync signal error detection portion, wherein the optical scanner scans the video signal according to the horizontal sync signal corresponding to the operating frequency and the vertical sync signal having an adjusted frequency.

### BRIEF DESCRIPTION OF THE DRAWINGS

The above and other features and advantages of the present invention are described in detailed preferred embodiments thereof with reference to the attached drawings in which:

FIG. 1 is a graph showing the relationship between the driving angle and the frequency of the optical scanner;

FIG. 2 is a waveform diagram of a sync signal error between the drive signal waveform of the optical scanner and the horizontal and vertical sync signals of the video signal;

FIG. 3 is a flow chart for illustrating a method for scanning a video signal according to an embodiment of the present invention;

FIG. 4 is a flow chart for illustrating Operation 12 shown in FIG. 3;

FIG. 5 is a view showing that the sync signal error between the horizontal sync signal corresponding to the operating frequency and the vertical sync signal corresponding to the video signal can be adjusted in the video signal scanning method shown in FIG. 3;

FIG. 6 is a block diagram of the construction of an apparatus for scanning a video signal according to an embodiment of the present invention; and

FIG. 7 is a block diagram of the sync signal error detection portion shown in FIG. 6.

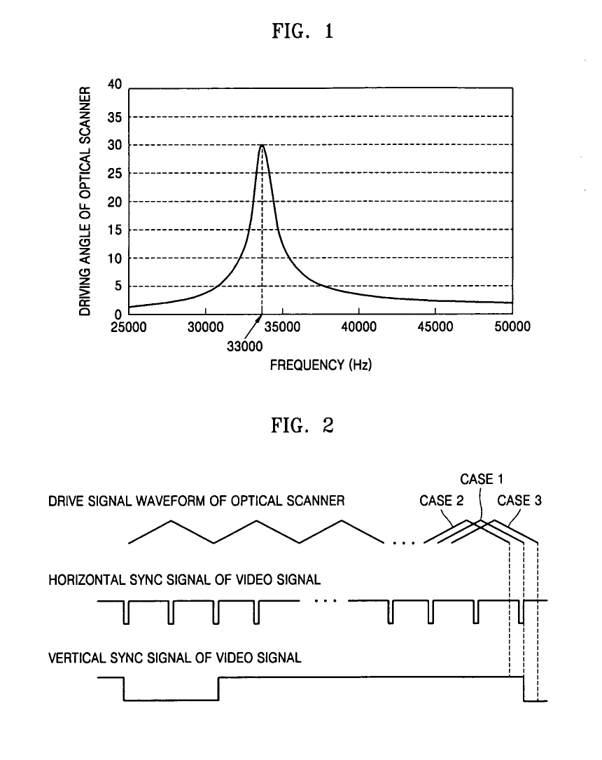

### DETAILED DESCRIPTION OF EXEMPLARY EMBODIMENTS

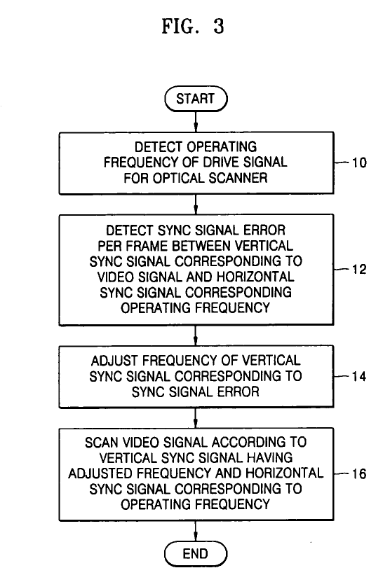

Referring to FIG. 3, in a method for scanning a video signal according to an embodiment of the present invention, the operating frequency of a drive signal to operate an optical scanner for scanning a video signal is detected (Operation 10). In particular, when the drive signal has a resonance frequency, the high speed operation of the optical scanner is made possible. The resonance frequency at this time is detected as the operating frequency of the drive signal.

After Operation 10, a sync signal error per frame between a vertical sync signal corresponding to the video signal and a horizontal sync signals corresponding to the drive signal is detected (Operation 12). A video signal per frame is scanned according to the vertical sync signal corresponding to the video signal and the horizontal sync signal corresponding to the operating frequency of the drive signal of the optical scanner. However, since the horizontal sync signal per frame according to the operating frequency of the drive signal for driving the optical scanner is not synchronized with the vertical sync signal of the video signal, an image is distorted. Thus, the sync signal error corresponding to a timing error between the vertical sync signal corresponding to the video signal per frame and the horizontal sync signal corresponding to the operating frequency is detected.

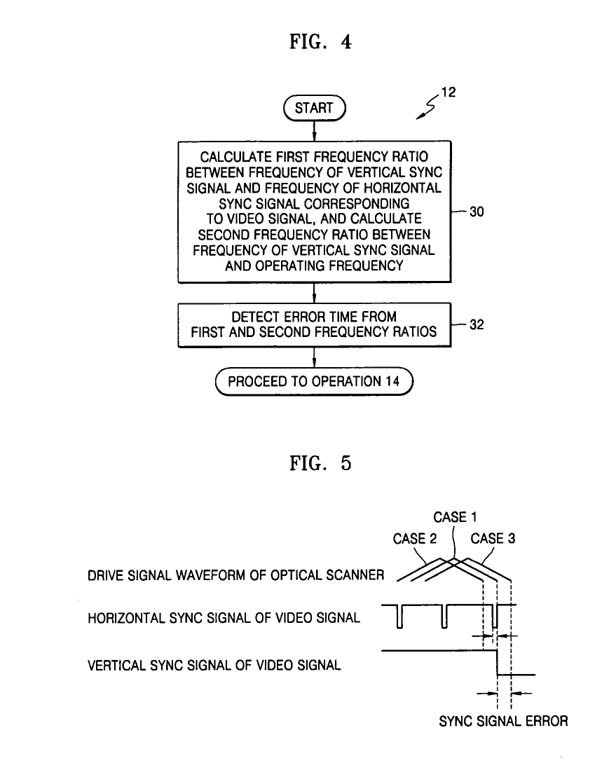

FIG. 4 is a flow chart for illustrating Operation 12 shown in FIG. 3. Referring to FIG. 4, a first frequency ratio between the frequency of the vertical sync signal corresponding to the video signal and the frequency of the horizontal sync signal corresponding to the video signal is calculated, and a second frequency ratio between the frequency of the vertical sync signal corresponding to the video signal and the operating frequency is calculated (Operation 30). For example, when the frequency of the vertical sync signal corresponding to the video signal is 60 Hz, the frequency of the horizontal sync signal corresponding to the video signal is 33,000 Hz, and the operating frequency is 33,006 Hz, the first and second frequency ratios are 1:550 and 1:550.1, respectively.

After Operation 30, error time corresponding to a sync signal error per frame between the vertical sync signal corresponding to the video signal and the horizontal sync signal corresponding to the operating frequency is detected from the calculated first and second frequency ratios (Operation 32). The following Equation 1 can be used to detect the error time.
Error Time={(Second Frequency Ratio−First Frequency Ratio)/Second Frequency Ratio}×Inverse Number of Vertical Sync Signal corresponding to Video Signal. Equation 1

For example, when the first frequency ratio is 1:550 and the second frequency ratio is 1:550.1, there is a difference of 0.1 (550.1−550=0.1) between the first and second frequency ratios. When “0.1” is divided by 550.1 that is the second frequency ratio and the result of the division (0.1/550.1) is multiplied by 1/60 (sec) that is the inverse number of the vertical sync signal corresponding to the video signal, the error time of (0.1/550.1)/60 can be obtained.

After Operation 12, according to the sync signal error, the frequency of the vertical sync signal is adjusted to make the horizontal sync signal corresponding to the operating frequency per frame synchronized with the vertical sync signal corresponding to the video signal (Operation 14). The frequency of the vertical sync signal is adjusted to match the error time corresponding to the sync signal error detected in Operation 12 with the horizontal sync signal corresponding to the operating frequency.

FIG. 5 is a view showing that the sync signal error between the horizontal sync signal corresponding to the operating frequency and the vertical sync signal corresponding to the video signal can be adjusted in a video signal scanning method. As shown in FIG. 5, when the sync signal error is generated between the drive signal waveform of the optical scanner and the vertical sync signal of the video signal (Case 2 or 3), the frequency of the vertical sync signal is adjusted in a direction indicated by an arrow so that the vertical sync signal is synchronized with the waveform of the drive signal of the optical scanner (Case 1).

After Operation 14, the video signal is scanned according to the horizontal sync signal corresponding to the operating frequency and the vertical sync signal having the adjusted frequency (Operation 16). That is, a video signal for the subsequent frame is scanned according to the vertical sync signal adjusted in Operation 14 and the horizontal sync signal corresponding to the operating frequency.

The above-described video signal scanning method is characterized in that the frequency of the vertical sync signal is adjusted for each frame. That is, the vertical sync signal is adjusted based on the video signal corresponding to one frame through the above process and the video signal of the subsequent frame is scanned according to the adjusted vertical sync signal. Also, the vertical sync signal is adjusted based on the video signal of the subsequent frame and the video signal of the subsequent frame is scanned according to the adjusted vertical sync signal. By repeating the above process, the distortion of an image according to the sync signal error can be prevented.

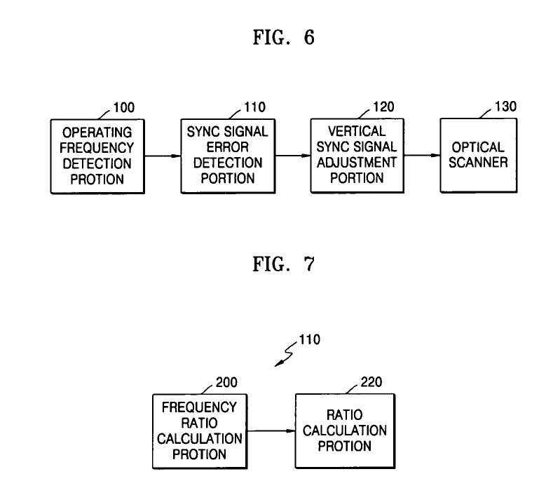

FIG. 6 is a block diagram of the construction of an apparatus for scanning a video signal according to an embodiment of the present invention. Referring to FIG. 6, a video signal scanning apparatus according to an embodiment of the present invention includes an operating frequency detection portion 100, a sync signal error detection portion 110, a vertical sync signal adjustment portion 120, and an optical scanner 130.

The operating frequency detection portion 100 detects the operating frequency of the drive signal for the optical scanner 130, and outputs the detection result to the sync signal error detection portion 110. The operating frequency detection portion 100 characteristically detects the resonance frequency of the drive signal for the high speed operation of the optical scanner 130 as the operating frequency.

The sync signal error detection portion 110 detects a sync signal error per frame between the vertical sync signal corresponding to the video signal and the horizontal sync signal corresponding to the operating frequency, and outputs the detection result to the vertical sync signal adjustment portion 120.

FIG. 7 is a block diagram of the sync signal error detection portion 110 shown in FIG. 6. Referring to FIG. 7, the sync error detection portion 110 includes a frequency ratio calculation portion 200 and an error time detection portion 220. The frequency ratio calculation portion 200 calculates the first frequency ratio between the frequency of the vertical sync signal corresponding to the video signal and the frequency of the horizontal sync signal corresponding to the video signal and the second frequency ratio between the frequency of the vertical sync signal corresponding to the video signal and the operating frequency, and outputs the calculation results to the error time detection portion 220. For example, when the frequency of the vertical sync signal corresponding to the video signal is 60 Hz, the frequency of the horizontal sync signal corresponding to the video signal is 33,000 Hz, and the operating frequency is 33,006 Hz, the frequency ratio calculation portion 200 calculates the first and second frequency ratios to be 1:550 and 1:550.1, respectively.

The error time detection portion 220, in response to the calculation result of the frequency ratio calculation portion 200, detects the error time corresponding to the sync signal error per frame between the vertical sync signal corresponding to the video signal and the horizontal sync signal corresponding to the operating frequency. The error time detection portion 220 can detect the error time using Equation 1. For example, when the first and second frequency ratios are 1:550 and 1:550.1, respectively, and the inverse number of the vertical sync signal corresponding to the video signal is 1/60 Hz, the error time detection portion 220 obtains the error time of (0.1/550.1)/60 while using Equation 1.

The vertical sync signal adjustment portion 120, in response to the detection result of the sync signal error detection portion 110, adjusts the frequency of the vertical sync signal such that the horizontal sync signal corresponding to the operating frequency per frame is synchronized with the vertical sync signal corresponding to the video signal, and outputs the adjustment result to the optical scanner 130. The optical scanner 130 scans the video signal according to the horizontal sync signal corresponding to the operating frequency and the vertical sync signal having an adjusted frequency.

The above-described video signal scanning apparatus is characterized in that the frequency of the vertical sync signal is adjusted for each frame. While this invention has been particularly shown and described with reference to preferred embodiments thereof, it will be understood by those skilled in the art that various changes in form and details may be made therein without departing from the spirit and scope of the invention as defined by the appended claims.

As described above, in the video signal scanning method and apparatus according to the present invention, the sync signal error between the horizontal sync signal corresponding to the drive signal for the optical scanner and the vertical sync signal of the video signal is adjusted so that the video signal is scanned according to the adjusted vertical sync signal. Thus, the distortion of the image formed by the video signal is prevented.

What is claimed is:

1. A method for scanning a video signal comprising:
detecting an operating frequency of a drive signal for an optical scanner which scans the video signal;
detecting a sync signal error per frame between a vertical sync signal corresponding to the video signal and a horizontal sync signal corresponding to the operating frequency;
adjusting a frequency of the vertical sync signal to allow the horizontal sync signal corresponding to the operating frequency to be synchronized with the vertical sync signal corresponding to the video signal, for each frame, in response to the sync signal error; and
scanning the video signal according to the horizontal sync signal corresponding to the operating frequency and the vertical sync signal having an adjusted frequency.

2. The method as claimed in claim 1, wherein, in the detecting of the operating frequency of the drive signal for the optical scanner, a resonance frequency of the drive signal for the high speed operation of the optical scanner is detected as the operating frequency.

3. The method as claimed in claim 1, wherein the detecting of the sync signal error per frame comprises:
calculating a first frequency ratio between the frequency of the vertical sync signal corresponding to the video signal and the frequency of the horizontal sync signal corresponding to the video signal and a second frequency ratio between the frequency of the vertical sync signal corresponding to the video signal and the operating frequency; and
detecting error time corresponding to the sync signal error per frame between the vertical sync signal corresponding to the video signal and the horizontal sync signal corresponding to the operating frequency, from the calculated first and second frequency ratios,
wherein, in adjusting of the frequency of the vertical sync signal, the frequency of the vertical sync signal is adjusted corresponding to the error time.

4. The method as claimed in claim 1, wherein the frequency of the vertical sync signal is adjusted for each frame.

5. An apparatus for scanning a video signal comprising:
an optical scanner which scans a video signal;
an operating frequency detection portion which detects an operating frequency of a drive signal for the optical scanner;
a sync signal error detection portion which detects a sync signal error per frame between a vertical sync signal corresponding to the video signal and a horizontal sync signal corresponding to the operating frequency; and
a vertical sync signal adjustment portion which adjusts a frequency of the vertical sync signal to allow the horizontal sync signal corresponding to the operating frequency to be synchronized with the vertical sync signal corresponding to the video signal, for each frame, in response to the detection result of the sync signal error detection portion,
wherein the optical scanner scans the video signal according to the horizontal sync signal corresponding to the operating frequency and the vertical sync signal having an adjusted frequency.

6. The apparatus as claimed in claim 5, wherein the operating frequency detection portion detects a resonance frequency of the drive signal for the high speed operation of the optical scanner as the operating frequency.

7. The apparatus as claimed in claim 5, wherein the sync signal error detection portion comprises:
a frequency ratio calculation portion which calculates a first frequency ratio between the frequency of the vertical sync signal corresponding to the video signal and the frequency of the horizontal sync signal corresponding to the video signal and a second frequency ratio between the frequency of the vertical sync signal corresponding to the video signal and the operating frequency; and
an error time detection portion which detects error time corresponding to the sync signal error per frame between the vertical sync signal corresponding to the video signal and the horizontal sync signal corresponding to the operating frequency, in response to the result of the calculation of the frequency ratio calculation portion,
wherein the vertical sync signal adjustment portion adjusts the frequency of the vertical sync signal corresponding to the error time.

8. The apparatus as claimed in claim 5, wherein the frequency of the vertical sync signal is adjusted for each frame.
